(19) United States
(12) Patent Application Publication
(10) Pub. No.: US 2015/0096926 A1
(43) Pub. Date: Apr. 9, 2015

(54) METHOD AND APPARATUS FOR CONTROLLING THE FLOTATION PROCESS OF PYRITE-CONTAINING SULPHIDE ORES

(71) Applicant: Outotec (Finland) Oy, Espoo (FI)

(72) Inventors: Mika Eteläpää, Mikkeli (FI); Gennady Nikolaevich Mashevskiy, St. Petersburg (RU); Aleksandr Vladimirovich Petrov, St. Petersburg (RU); Sergei Aleksandrovich Romanenko, St. Petersburg (RU)

(73) Assignee: OUTOTEC (FINLAND) OY, Espoo (FI)

(21) Appl. No.: 14/399,449

(22) PCT Filed: May 10, 2012
(86) PCT No.: PCT/RU2012/000398

§ 371 Date: Nov. 6, 2014

(51) Int. Cl. B03D 1/02; B03D 1/14

(52) U.S. Cl. CPC B03D 1/028; B03D 1/14; B03D 2203/02
USPC 209/571

(57) ABSTRACT

Method and apparatus for controlling the flotation process of sulphide ores including separation of sulphide minerals from pyrite in an alkaline environment created by lime. The method comprises measuring the molybdenum electrode potential of an aqueous slurry of the ore and adjusting the addition of lime based on the measured molybdenum electrode potential to maintain the molybdenum electrode potential of the slurry in a preselected range. The apparatus comprises means (6) for measuring the molybdenum electrode potential and a control unit (7) for controlling the addition of lime to the slurry based on the measured molybdenum electrode potential of the slurry.

### FIELD OF THE INVENTION

The invention relates to a method for controlling the flotation process of sulphide ores including separation of sulphide minerals from pyrite in an alkaline environment created by lime. The invention also relates to an apparatus for controlling such flotation process.

### BACKGROUND OF THE INVENTION

Flotation process which includes separation of sulphide minerals from pyrite by adjusting lime (CaO) dosage is one of the most common processes used in concentration plants throughout the world. The process is used, for instance, in beneficiation of copper, copper-zinc, copper-nickel, copper-molybdenum, and complex ores.

Each flotation process has an optimal electrochemical state that leads to the best possible metallurgical performance. In flotation practice, methods are known for controlling the feed of sulphidizing agent (e.g. Na₂S) based on the measurement of electrochemical potential (Eh) of an aqueous ore slurry with the help of a platinum electrode. Examples of such methods are disclosed, for instance, in patent documents U.S. Pat. No. 4,011,072 A and U.S. Pat. No. 3,883,421 A. These methods relate to flotation processes aiming at sulphidizing oxidized forms of copper minerals. Such methods cannot be directly applied to flotation separation of sulphide minerals from pyrite, since Na₂S applied in those methods would result in activation of pyrite flotation.

Lime addition in selective flotation of sulphide minerals from pyrite is usually controlled based on hydrogen ion concentration measured from the slurry, or based on the conductivity of the slurry. In spite of the high importance of separation of sulphide minerals from pyrite, there are no examples of reliable implementation of such flotation control systems in industrial conditions. The reasons for this will be discussed in the following.

Low sensitivity of glass electrodes with highly alkaline slurry is one of the problems. Selective flotation of pyrite-containing sulphide ores is usually carried out at a pH of about 12.0-12.2.

Fouling of electrode surface with films of Ca(OH)₂ and mineral particles of the processed ore is another problem. Attempts have been made to clean the 1.5 electrode surface mechanically or by washing with water or acid. These procedures significantly complicate the design of the measurement sensor. Still, they do not ensure reliable operation of the pyrite separation process.

The feasibility of eliminating sensor fouling by means of natural peeling of the sensor surface with the slurry flow is excluded because a glass electrode would break in such treatment.

High sensor impedance (over 1000 MOhm) requires special ionometers with a high-resistance input and protection of connecting cables and connectors from the influence of electromagnetic fields of motors installed in the flotation building, as well as taking measures to prevent the ingress of moisture, vapours and steam condensation into the fixture with the help of which the sensor is installed into the slurry.

A glass electrode does not react on changes in the redox-potential of the slurry.

Special researches conducted in a concentration plant beneficiating Cu—Zn ore confirmed the unreliability of using conventional process control with a pH sensor during the separation of copper minerals from pyrite. The measurement results of the industrial sensor installed directly in a flotation cell and the measurement results of a pH sensor installed in a test flow-through cuvette were compared. The trend of the sensor installed in the flotation cell demonstrated first a gradual decrease of pH values and then a total failure of the pH control system. Thus there is a great risk that the pH sensor installed directly in the flotation cell misinforms the process control operator.

Instability and low efficiency of pH based control of flotation process during separation of sulphide minerals from pyrite has also been discovered when analysing the operation of another industrial concentration plant treating complex ore.

A second industrially implemented way of controlling the flotation separation of sulphide minerals from pyrite is to adjust the CaO dosage according to the slurry conductivity value. Taking into account the particularities of the ionic composition of flotation slurries, this method has numerous disadvantages. Apart from the residual concentration of CaO, the conductivity of the slurry is also considerably influenced by the amount of ZnSO₄ electrolyte dosage into the slurry, which is widely used, especially when treating Zn-containing ores, as well as by any dosage of other reagents. Apart from H⁺ and OH⁻ ions, the slurry conductivity is also influenced by the soluble components of the processed ore and the composition of circulation water, which may contain Na⁺, K⁺, Cl⁻, S²⁻, SO₃²⁻, S₂O₃²⁻, S₄O₆²⁻, SO₄²⁻ and many other ions. A close correlation can be observed in an industrial concentrator plant between the slurry conductivity and the electrochemical potential within short time periods, but this correlation falls almost to zero within a couple of days.

In a Finnish industrial concentration plant, in order to control the operation of a conductometric analyser, manual slurry pH control of the industrial slurry is performed daily every 3-4 hours in the laboratory. Hence the control method is laborious.

A control method based on conductometric monitoring of the residual CaO concentration does not eliminate the disadvantage of sensor element fouling with films of Ca(OH)₂ and mineral particles of the processed ore.

Xanthates are often used as collectors in flotation of sulphide ores. Implementation of a flotation method comprising pyrite depression by means of lime provides for preventing the oxidation of xanthate ions into dixanthogenide, which is a pyrite collector:

2X⁻→X₂+2e⁻ (1)

In other words, the pyrite depression process also depends on the electrochemical potential of the slurry, the value of which should be aimed at shifting the reaction (1) to the left side. This fact is not taken into account when implementing the present pyrite separation process control, which is realised in practice only by controlling the concentration of H⁺ ions in the slurry based on a selective glass electrode for pH measurement. This can be considered as the main technological drawback of the current process of separating sulphide minerals from pyrite. This fact has also been verified in practice. During different operation periods in an industrial concentration plant, with the same “optimum” pH value 12.0-12.5, electrochemical potential values of different heights were registered. Higher electrochemical potentials were found to result in higher pyrite floatability and disruption of flotation selectivity.

The object of the present invention is to overcome the problems faced in the prior art.

More precisely, the object of the present invention is to improve the control of conditions in a flotation process that comprises selective separation of sulphide minerals from pyrite in an alkaline environment created by addition of lime.

### SUMMARY

According to the present invention, a method for controlling the flotation process of sulphide ores including separation of sulphide minerals from pyrite in an alkaline environment created by lime comprises measuring the molybdenum electrode potential of an aqueous slurry of the ore and adjusting the addition of lime based on the measured molybdenum electrode potential to maintain the molybdenum electrode potential of the slurry in a preselected range.

Preferably, the molybdenum electrode and a reference electrode (Ag/AgCl) are placed at a point where the slurry is in flow, for instance, in a feed line or in an intensively agitated section of a flotation cell. This prevents fouling of the electrode surface with Ca(OH)₂ films and mineral particles of the processed slurry.

Reliability of electric measurements can be increased by using a low-resistance electrode, preferably one having a resistance below 1.0 ohm.

The optimum range for the molybdenum electrode potential, which is used as the preselected range in an automatic control loop, can be defined experimentally in each case.

According to the present invention, an apparatus for controlling the flotation process of sulphide ores including separation of sulphide minerals from pyrite in an alkaline environment created by lime comprises means for measuring the molybdenum electrode potential of an aqueous slurry and means for controlling the addition of lime based on the measured molybdenum electrode potential to maintain the molybdenum electrode potential of the slurry in a preselected range.

Preferably, the means for controlling the addition of lime comprise means for comparing the measured molybdenum electrode potential with the preselected range and means for changing the feed rate of lime to the slurry if the measured molybdenum electrode potential deviates from the preselected range.

### BRIEF DESCRIPTION OF THE DRAWINGS

In the following the principles of the invention are explained with reference to the appended drawings, where:

FIG. 1 is a schematic representation of a control system for a flotation process according to the present invention.

FIG. 2 is a diagram illustrating three-dimensionally lead losses with tailings as a function of pH and molybdenum electrode potential.

FIG. 3 is a diagram illustrating copper concentrate grade and copper losses with tailings as a function of molybdenum electrode potential.

FIG. 4 is a diagram illustrating the final copper concentrate grade in the form of isolines as a function of molybdenum electrode potential and pH.

### DETAILED DESCRIPTION OF THE INVENTION

Stemming from the physical-chemical nature of the flotation process in separating sulphide minerals from pyrite, the new control method comprises adjusting lime dosage based on the molybdenum electrode potential measured from the ore slurry. The possibility of pH control using metal-oxide electrodes is well-known from the theory of electrochemistry, but it has not before been used in the present context.

Formation of molybdenum electrode potential is determined by an electrochemical reaction:

MoO₂+H₂O=MoO₃+2H⁺+2e⁻ (2).

Since H⁺ ion participates in the reaction (2), the molybdenum electrode potential simultaneously controls the pH and the redox potential of the slurry.

Redox potential measurement indicates the reduction/oxidation potential of a solution. Redox potential is obtained by measuring the electrode potential of a redox electrode against a reference electrode. Usually, a platinum electrode is used in the measurement. However, platinum electrode is very unstable in terms of slurry composition; for instance, a platinum electrode is influenced by the concentration of oxygen and hydrogen in the slurry. Platinum electrode is very sensitive to ions of bivalent iron, which often appear in ore slurries. The instability of the properties of platinum electrode is associated with the method of its manufacture: presence of atomic impurities from other metals in platinum, electrode shape, method of its surface processing.

In a flotation system for pyrite-containing copper ores, the ore is first crushed and ground with lime usually added as an aqueous solution to depress pyrite. The ore is then treated in a primary flotation circuit after a suitable copper collector and frother have been added. The copper rougher concentrate thus obtained contains most of the copper of the ore. This copper rougher concentrate is then subjected to several stages of cleaner flotation, usually after a regrind operation, to produce a finished copper concentrate. The new control method can be used at any stage of a flotation process used for separation of copper, or any other valuable sulphide minerals, such as Zn, Pb, Mo, Ni, from pyrite in an alkaline environment created by lime.

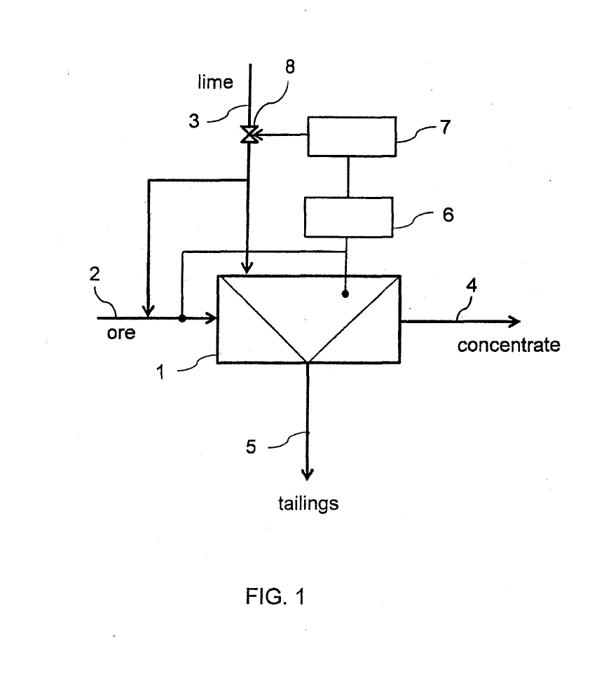

The principles of the flotation process and the control system according to the present invention are illustrated in FIG. 1. An aqueous ore slurry is fed to a flotation cell 1 via a slurry feed Line 2. Lime or lime milk is added to the slurry via a Lime feed line 3 in an ore mill (not shown), in a conditioner (not shown) and/or in the flotation cell 1. The goal of flotation is to separate valuable sulphide minerals from pyrite and gangue minerals such that the former are transferred to concentrate 4 and the Latter are transferred to tailings 5.

The redox-potential of the slurry is measured by measuring means 6 which comprise, among other things, a molybdenum electrode and a reference electrode, preferably an Ag/AgCl-electrode. Both electrodes are placed either in the slurry feed Line 2 or in the flotation cell 1. It is important the electrodes are placed at a point where the slurry is in motion.

The measuring means 6 provide a measurement signal, which is transmitted to a control unit 7. The control unit 7 compares the measured molybdenum electrode potential with a preselected range given to the molybdenum electrode potential. If the measured value is not within the preselected range, the control unit 7 transmits a control signal to an actuator 8 controlling the lime feed.

Advantageously, the optimum range for molybdenum electrode potential to be used as the preselected range in the control system should be defined experimentally in each case.

The invention is further illustrated below by reference to specific examples. However, the scope of the present invention is not limited to these examples.

### EXAMPLE 1

A comparative evaluation of three different control methods that can be used in selective flotation separation of sulphide minerals from pyrite in a lime environment was carried out in an industrial concentration plant with the help of neural network modeling. The concentration plant in question beneficiates Cu—Zn ore. Neural networks, with their remarkable ability to derive meaning from complicated or imprecise data, are a feasible tool for extracting patterns and detecting trends that are too complex to be noticed by either humans or other computer techniques.

The evaluated three methods comprise controlling the conditions in flotation process based on: pH control, conductometric method, and redox-potential (Eh). Measurements of redox-potential and pH were performed by installing the respective electrodes in a flow-through cell in a Chena® system installed in the slurry flow fed into a rougher copper flotation. These results were compared with results of conductometric measurement system which was installed at the same process point. Information on metal content, section load and reagent dosage was received from Outotec Proscon® automation system during the period of conducting the tests.

The results of the neural network modeling of the sensitivity of each process control method are given in Tables 1-3. In each table, process load presents the load of the observed process stage in terms of tons of ore per hour. Fe in feed (or Cu, Zn, Pb, S in feed) presents the iron content (or copper, zinc, lead, sulphur content) in the incoming ore. Xanthate consumed (or ZnSO₄, CaO consumed) presents the amount of xanthate (or ZnSO₄, CaO) consumed in the ore mill.

Table 1 shows the neural network model for pH control, Table 2 shows the neural network model for conductometric method and Table 3 shows the neural network model for redox potential (Eh) based control system.

As expected, the method employing process control based on pH (Table 1) responds to CaO consumption and copper content of the ore in the first place and to other changes in the composition of the processed ore in the last place.

The method employing process control based on conductometric method (Table 2) responds to ZnSO₄ feed and to zinc and copper contents of the ore in the first place.

The process control based on the redox potential (Table 3) responds to the composition of the processed raw materials in the first place. This explains the reason of the optimality of this parameter when implementing the control method according to the present invention.

The neural network model for Eh parameter is noted for its better appropriateness for the discussed site. The correlation factor for the model is evaluated as R=0.947. For the flotation process control based on pH the model appropriateness is evaluated as R=0.657. When using a conductometric method, the value of R is 0.889.

### EXAMPLE 2

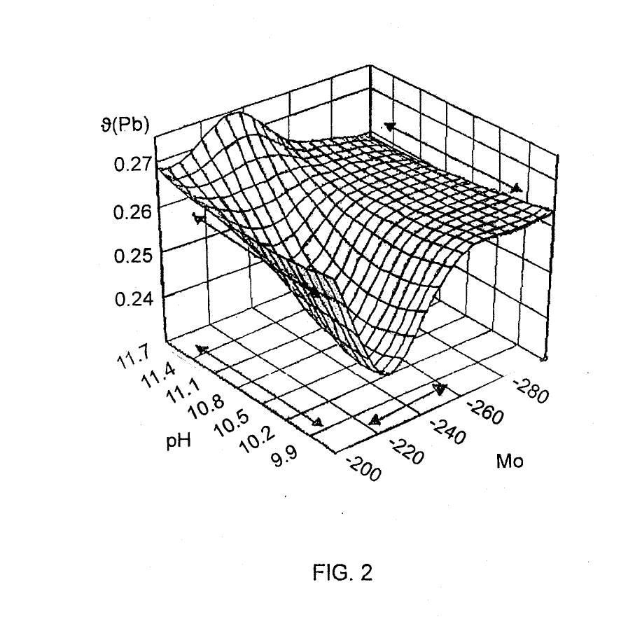

The optimality of using molybdenum electrode potential in flotation control was further confirmed by comparative tests with molybdenum and pH electrodes. The tests were performed in a concentration plant treating polymetal ores. FIG. 2 shows the response of an output function—lead losses with tailings (θ(Pb))—during neural network modeling against the change of the slurry pH and the electrochemical potential measured using a molybdenum electrode. From FIG. 2 one can clearly see the availability of an optimum molybdenum electrode potential at which Load losses with tailings are minimal, whereas this is not the case with pH values. On the shown response surface there is almost no influence of pH value variation, or there is a linear dependency necessitating reduction of pH value in order to decrease the loss of lead with tailings, in which case increased pyrite floatability is inevitable.

### EXAMPLE 3

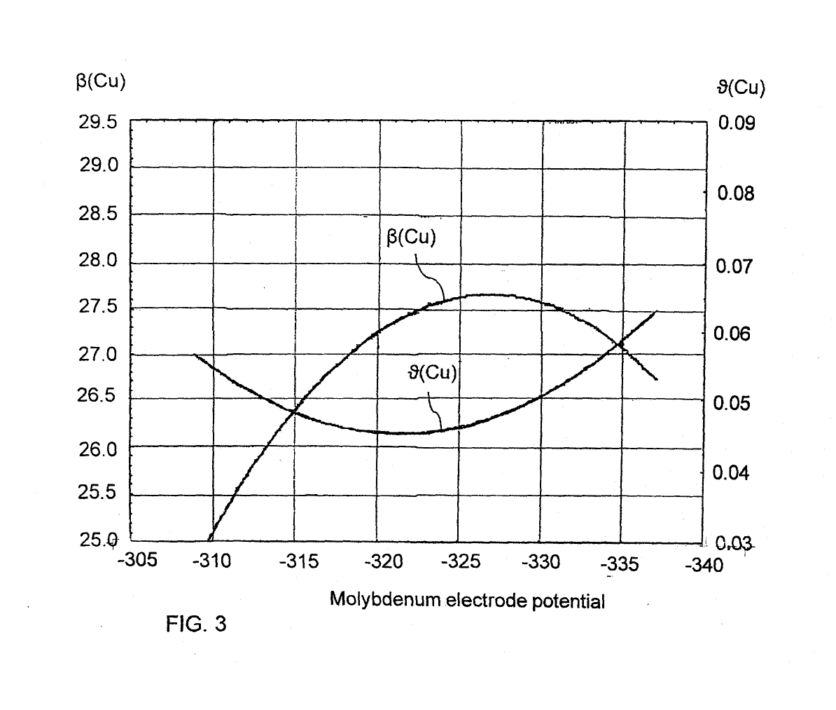

The method according to the present invention was tested during the treatment of Cu—Zn pyrite ore in an industrial concentration plant in a copper flotation circuit where CaO is fed into ore mills. Apart from CaO, ZnSO₄ is also fed into the ore mills for sphalerite depression, and xanthate is used as a collector for copper minerals. Correlation of molybdenum electrode potential with the produced copper concentrate grade β(Cu) and copper losses with the circuit tailings θ(Cu) is presented in FIG. 3. The figure reveals an optimum of molybdenum electrode potentials at an area around −325 mV, where the highest copper concentrate grade and the minimum copper losses with tailings are achieved. When the molybdenum electrode potential is higher than the optimum, process parameters are naturally lower due to the shift of the reaction (1) balance to the right side. According to the present invention, high molybdenum electrode potential necessitates increased CaO addition. Process parameters are decreased as well with low molybdenum electrode potentials, which is explained by the Formation of complex compounds of type [Zn(OH)X₂]⁻ in this area. Formation of said complex has been confirmed by special electrochemical measurements in rougher copper flotation. Decrease of the activity of the ionic form of xanthate is a reason for the increase of copper losses with section tailings.

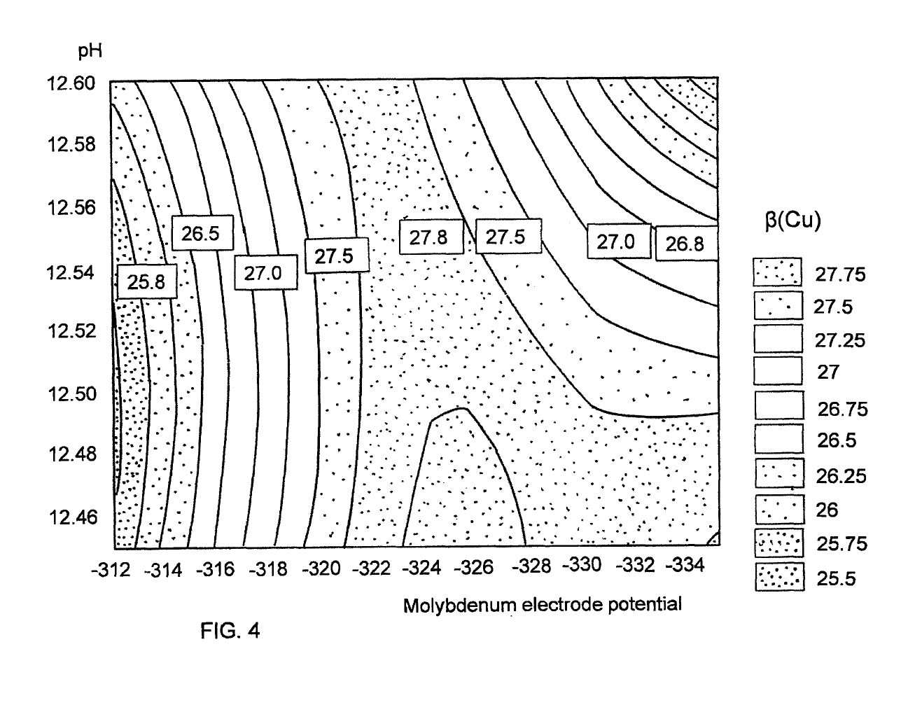

The advantage of controlling the molybdenum electrode potentials in the implementation of the present method compared to controlling the pH parameter is further confirmed by FIG. 4. The figure shows a plane in the coordinate system of molybdenum electrode potential and pH in which isolines of the final copper concentrate grade are plotted. A clear dependence of copper concentrate grade and molybdenum electrode potential variation can be observed. The dependence of copper concentrate grade and pH is much weaker.

### EXAMPLE 4

The control method according to the present invention was tested during treatment of pyrite-containing copper ore in an industrial concentration plant in the coarse copper concentrate cleaner circuit, where CaO is fed into a regrind mill.

The correlation of process parameters—produced copper concentrate grade β(Cu) and copper losses in the circuit tailings θ(Cu)—and molybdenum electrode potentials followed a similar pattern as in FIG. 3. The area of optimum values of molybdenum electrode potentials was found to be close to the area of optimum values of molybdenum electrode potentials discovered in Example 3. Control measurements of hydrogen parameter value in that area correspond to pH=12.2.

The above results indicate that it is possible to optimize the selective flotation of sulphide minerals from pyrite by measuring the molybdenum electrode potential and by adjusting the lime addition based on the measured electrode potential.

It is evident that the optimum molybdenum electrode potential may vary in different concentration plants based on the differences in the ore composition and other process conditions. That is why the optimum range of molybdenum electrode potential should be separately defined for each individual case.

It is obvious to a person skilled in the art that with the advancement of technology, the basic idea of the invention may be implemented in various ways. The invention and its embodiments are thus not limited to the examples described above; instead they may vary within the scope of the claims.

TABLE 1

| | Process | Fe in | Cu in | Zn in | Pb in | S in | Xanthate | ZnSO₄ | CaO |
|---|---|---|---|---|---|---|---|---|---|
| pH | load | feed | feed | feed | feed | feed | consumed | consumed | consumed |
| Relation.23 | 1.093 | 1.109 | 1.233 | 0.980 | 1.106 | 1.111 | 1.211 | 1.226 | 1.239 |
| Rank.23 | 8 | 6 | 2 | 9 | 7 | 5 | 4 | 3 | 1 |

TABLE 2

| | Process | Fe in | Cu in | Zn in | Pb in | S in | Xanthate | ZnSO₄ | CaO |
|---|---|---|---|---|---|---|---|---|---|
| Conductometrics | load | feed | feed | feed | feed | feed | consumed | consumed | consumed |
| Relation.3 | 0.990 | 1.096 | 1.509 | 1.582 | 1.199 | 1.113 | 1.081 | 1.596 | 1.368 |
| Rank.3 | 9 | 7 | 3 | 2 | 5 | 6 | 8 | 1 | 4 |

TABLE 3

| | Process | Fe in | Cu in | Zn in | Pb in | S in | Xanthate | ZnSO₄ | CaO |
|---|---|---|---|---|---|---|---|---|---|
| Eh | load | feed | feed | feed | feed | feed | consumed | consumed | consumed |
| Relation.14 | 0.975 | 1.084 | 1.955 | 1.948 | 1.342 | 1.112 | 1.006 | 1.608 | 1.214 |
| Rank.14 | 9 | 7 | 1 | 2 | 4 | 6 | 8 | 3 | 5 |

1. A method for controlling the flotation process of sulphide ores including separation of sulphide minerals from pyrite in an alkaline environment created by lime, the method characterized by measuring a molybdenum electrode potential of an aqueous slurry of the ore and adjusting the addition of lime based on the measured molybdenum electrode potential to maintain the molybdenum electrode potential of the slurry within a preselected range.

2. A method according to claim 1, characterized by measuring the molybdenum electrode potential while the slurry is in flow.

3. A method according to claim 1, characterized by using a low-resistance molybdenum electrode.

4. A method according to claim 1, characterized by experimentally defining the optimum range for the molybdenum electrode potential to be used as the preselected range.

5. An apparatus for controlling the flotation process of sulphide ores including separation of sulphide minerals from pyrite in an alkaline environment created by lime, characterized in that the apparatus comprises at least one Instrument together capable of measuring the molybdenum electrode potential of an aqueous slurry of the ore and means capable of controlling the addition of lime based on the measured molybdenum electrode potential to maintain the molybdenum electrode potential of the slurry in a preselected range.

6. An apparatus according to claim 5, characterized in that the molybdenum electrode potential of the slurry is measured using a molybdenum electrode and a reference electrode placed at a point in the process where the slurry is in flow.

7. An apparatus according to claim 5, characterized in that the molybdenum electrode is a low-resistance electrode.

8. An apparatus according to claim 5, characterized in that the addition of lime is controlled by at least one instrument together capable of comparing the measured molybdenum electrode potential with the preselected range and capable of changing the feed rate of lime to the slurry if the measured molybdenum electrode potential deviates from the preselected range.

9. An apparatus according to claim 7, characterized in that the electrode has a resistance of less than 1.0 ohm.

10. An apparatus according to claim 6, characterized in that the molybdenum electrode is a low-resistance electrode.

11. An apparatus according to claim 10, characterized in that the electrode has a resistance of less than 1.0 ohm.

12. A method according to claim 2, characterized by experimentally defining the optimum range for the molybdenum electrode potential to be used as the preselected range.

13. A method according to claim 3, characterized by experimentally defining the optimum range for the molybdenum electrode potential to be used as the preselected range.

14. A method according to claim 2, characterized by using a low-resistance molybdenum electrode

15. A method according to claim 14, characterized in that the electrode has a resistance of less than 1.0 ohm.
